(19) United States
(12) Patent Application Publication
(10) Pub. No.: US 2005/0213231 A1
(43) Pub. Date: Sep. 29, 2005

(54) Backing mirror

(76) Inventor: Charles E. Harrison III, Martinsburg, WV (US)

Correspondence Address: CONNOLLY BOVE LODGE & HUTZ LLP, SUITE 800, 1990 M STREET NW, WASHINGTON, DC, 20036-3425, US

(21) Appl. No.: 10/810,722

(22) Filed: Mar. 29, 2004

(51) Int. Cl. G02B 7/182

(52) U.S. Cl. 359/879; 359/871

(57) ABSTRACT

A backing mirror is presented which mounts to a tow vehicle to facilitate visual alignment of hitch and tongue. Through articulated angular movement, the backing mirror is capable of being repeatably aligned to an appropriate position for visual observation of the coupling of trailer hitch and tongue on a given tow vehicle. An optional second mirror can be employed to facilitate a rearward field of view.

### FIELD OF THE INVENTION

The present invention relates generally to trailer hitch guides and, more particularly, to a trailer hitch backing mirror that facilitates coupling of trailer hitch and tongue.

### BACKGROUND OF THE INVENTION

Trailers and equipment are usually coupled to the rear of a tow vehicle for transport. Rear coupling of trailers requires use of rear mounting equipment, such as trailer hitch and tongue. The trailer hitch is mounted to the tow vehicle, and the trailer tongue is mounted to the trailer. Because trailer hitch and tongue mount to the rear of tow vehicles, it is necessary that the tow vehicle back up towards the trailer for coupling. Tow vehicles, such as trucks, are generally tall and difficult to see behind when backing up. Thus, it can be difficult to align hitch and tongue when the tow vehicle nears the trailer. When the trailer and load are light, alignment can be conducted manually by physical placement of the tongue over the hitch. Many trailers and equipment, however, are heavy and thus make manual manipulation of the trailer almost impossible for the average person. Thus, viewing mirrors are employed to facilitate vision of the hitch and tongue while attempting to couple the trailer to the tow vehicle.

Traditional viewing mirrors are typically located on the trailer itself. Mounting the viewing mirror on the trailer itself can be problematic, however, since the view in the mirror is only available when the tow vehicle is near the trailer. Also, trailer mounted mirrors are often permanently attached to the trailer, which requires purchase of a separate mirror for each trailer owned. Additionally, permanently mounted mirrors are vulnerable to flying rocks and debris, as well as theft. With a trailer mounted mirror adjustment must necessarily be relative to the trailer and not the tow vehicle. Thus, it is difficult to calibrate the alignment of the trailer hitch and tongue from the perspective of the tow vehicle. Other traditional viewing mirrors mount on the tow vehicle itself, but these traditional mirrors lack flexibility in their ability to mount on various locations of the tow vehicle. Also, traditional vehicle mounted mirrors lack an ability to be calibrated for quick and accurate positioning at each of such various locations. Accordingly, what is needed is a viewing mirror that facilitates alignment of trailer hitch and tongue in a flexible manner that lends itself to quick and efficient operation, and is simple to apply, preferably for use with multiple vehicles.

### SUMMARY OF THE INVENTION

Aspects of the present invention include a backing mirror assembly comprising a mirror assembly; a substrate coupled to the mirror. The substrate is adapted to support and retain the mirror. There is also included a shaft, formed of one or more components, coupled to the substrate; as well as at least one angulated position holders rotatably coupled to the substrate and adapted to receive said shaft; and support structure coupled to the substrate. At least one angulated position holder is located between the substrate and the support structure to facilitate rotational movement of the substrate relative to the support structure.

Another aspect of the present invention includes a backing mirror assembly comprising a first mirror and a substrate coupled to the first mirror. The substrate is adapted to support and retain the first mirror. The assembly also includes a shaft, formed of at least one component coupled to the substrate; as well as at least one angulated position holder that is rotatably coupled to the substrate and adapted to receive the shaft. There is also included a support structure coupled to the substrate, the at least one angulated position holder is located between the substrate and the support structure to facilitate rotational movement of the substrate relative to the support arms. There is also included a second mirror coupled to the support structure.

A further aspect of the present invention includes a backing mirror assembly comprising a mirror having guidance indicia; a substrate coupled to the mirror, wherein the substrate is adapted to support and retain the mirror. A shaft, formed of at least one component, is coupled to the substrate; and at least one angulated position holder is rotatably coupled to the substrate and adapted to receive the shaft. There is also provided a support structure coupled to the substrate, wherein the at least one angulated position holder is located between the substrate and the support structure to facilitate rotational movement of the substrate relative to the support structure.

Yet another aspect of the present invention includes a method of using a backing mirror, the method comprising attaching a backing mirror to a vehicle having a tow hook-up, and backing mirror having an angulated position holder coupled to a support structure. The backing mirror is initialized to a reference position and rotated via the angulated position holder for a predetermined quantity of units from the reference position to a viewing position. The units represent discrete stepwise rotational advancement configured to impart tactile registry, and the predetermined quantity of units establish the backing mirror as being vertically aligned relative to the particular vehicle being towed, so as to be in optical communication with the tow hook-up.

Another aspect of the present invention includes a mirror assembly for use with a towing vehicle and a towed vehicle, the assembly comprising a first and second mirror, at least one of the mirrors being convex, said mirrors being adapted to be coupled to a vehicle via at least one position holder, at least one of the mirrors including reference indicia capable of providing confirmation of accurate placement of the towing vehicle with said towed vehicle.

A further aspect of the present invention includes a mirror assembly for use with a towing vehicle and a towed vehicle, the assembly comprising at least one mirror capable of being attached to the towing vehicle via at least one position holder, the position holder including means for rotating the mirror to at least two positions, the positions being held in place via a ratchet mechanism and the positions being associated with a predetermined desired placement of the mirror so as to align the towing vehicle with the towed vehicle.

Additional objects, features and advantages of the invention will be set forth in the description which follows, and in part, will be obvious from the description, or may be learned by practice of the invention. Objects, features and advantages of the invention may be realized and obtained by means of the instrumentalities and combination particularly pointed out in the appended claims.

### BRIEF DESCRIPTION OF THE DRAWINGS

FIG. 1A illustrates a perspective view of a backing mirror in accordance with an embodiment of the present invention.

FIG. 1B illustrates a perspective view of a backing mirror having an adjustable support structure in accordance with an embodiment of the present invention.

FIG. 2 illustrates an elevation view of an angulated position holder in accordance with an embodiment of the present invention.

FIG. 3 illustrates an elevation view of a backing mirror employing a second mirror in accordance with an embodiment of the present invention.

FIG. 4 illustrates an elevation view of a backing mirror initialized to a reference position in accordance with an embodiment of the present invention.

FIG. 5 illustrates a flow diagram presenting a method of using a backing mirror in accordance with an embodiment of the present invention.

FIG. 6A illustrates a perspective view of a backing mirror mounted on a tow vehicle in accordance with an embodiment of the present invention.

FIG. 6B illustrates an elevation view of a backing mirror mounted on a tow vehicle showing hitch and tongue prior to coupling in accordance with an embodiment of the present invention.

FIG. 7A illustrates a mirror view of a backing mirror prior to alignment of hitch and tongue in accordance with an embodiment of the present invention.

FIG. 7B illustrates a mirror view of a backing mirror when the hitch and tongue are aligned in accordance with an embodiment of the present invention.

FIG. 8 illustrates a mirror view of a backing mirror employing a second mirror in accordance with an embodiment of the present invention.

### DETAILED DESCRIPTION

A backing mirror is disclosed which mounts to a tow vehicle to facilitate visual alignment of trailer hitch and tongue. Typical trailers include RV, boat, horse, and equipment trailers. The present invention is not limited to such trailers, however, and is ideal for any kind of trailer, to wit, it adapted to be used with any towing application. A trailer hitch and tongue are located behind most towing vehicles and out of the field of view of a driver attempting to attach a trailer. The backing mirror permits a downward, vertical field of view so that a driver can observe the coupling of hitch and tongue from the cab of the vehicle. Articulated angular movement enables the backing mirror to be repeatably aligned to an appropriate position for visual observation of trailer hitch and tongue coupling on a given tow vehicle. An optional second mirror is available as an attachment to facilitate a rearward field of view.

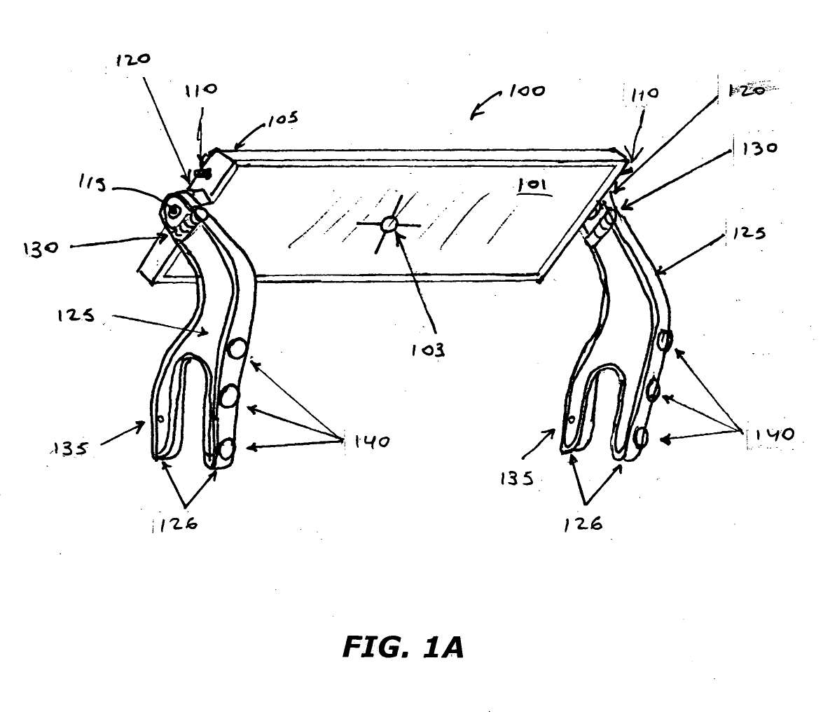

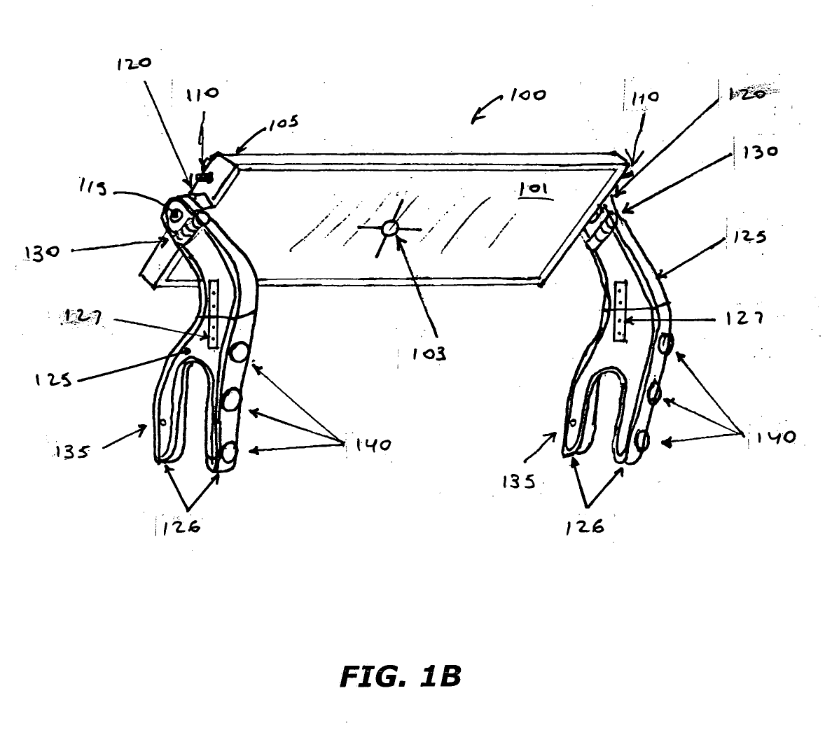

FIG. 1A illustrates a perspective view of backing mirror 100 in accordance with an embodiment of the present invention. Backing mirror 100 features mirror 101 coupled to substrate 105. Substrate 105 is configured to support and retain mirror 101 and may do so in a manner that would be known to those of ordinary skill in the art. For example, mirror 101 can be coupled to substrate 105 via an adhesive, or, alternatively, substrate 105 may form a frame having edges that fold over to retain mirror 101. Mirror 101 is not limited as to shape and can be formed of such shapes as, for example, rectangle, square, triangle, or circle. Mirror 101 may be flat, such as when a non-distorted view is desired, or may be convex, such as when a wide field of view is desired, or may be concave, such as when a narrow field of view is desired. As an optional feature, mirror 101 may possess guidance indicia 103. Guidance indicia 103 may be formed of any symbol, such as geometric shapes (for instance, circle, triangle and square), or markings, such as a cross or ‘X’, or combinations thereof. FIG. 1A illustrates optional guidance indicia 103 as a combination cross and circle. Guidance indicia 103 can be brightly colored for viewing ease. Guidance indicia 103 helps calibrate the alignment of the trailer hitch and tongue from the tow vehicle's perspective. In one embodiment, the guidance indicia 103 represents a bull's-eye type marking such as that typically associated with a target.

Substrate 105 is coupled to shaft 115. Shaft 115 provides an axis about which mirror 101 and substrate 105 may rotate. Shaft 115 may be a single, continuous length, or may be formed of segments. Shaft 115 is adapted to retain the components of backing mirror 100 and may do so in a manner that would be known to those of ordinary skill in the art. For example, shaft 115 may be threaded, in whole or in part, to receive a locking nut positioned on one or both of its ends, or, alternatively, shaft 115 may outfitted with one or more holes to receive locking pins, such as cotter pins. Coupled to substrate 105 are one or more stop-pegs 110, which serve to limit rotation of backing mirror 100 and locate reference positioning for initializing set-up of backing mirror 100.

Support structure 125 is coupled to substrate 105 and is the component of backing mirror 100 that facilitates installation of the unit on a tow vehicle, as well as to provide physical support for substrate 105 and mirror 101. In the embodiment illustrated in FIG. 1A, support structure 125 is formed of two components, each having mounting prongs 126 to facilitate mounting of the backing mirror on a rear door or tail-gate. Mounting prongs 126 form gaps which slip over a portion of a vehicle and the weight of the backing mirror 100 helps to maintain position. In one embodiment support structure 125 is universally configured in order to fit a variety of vehicles, but support structure 125 could be manufactured to uniquely fit a particular style or make of vehicle. When mounting the backing mirror 100 on the front of a vehicle, the support structure 125 can be adapted to fit on the front portion of a vehicle, such as hood or front bumper. For mounting against surfaces such as glass or outer vehicle surfaces, suction cups 140 are be provided. Suction cups 140 can be mounted on the side of support structure 125, as shown, or on the bottom for attachment to a vehicle hood or trunk. Other embodiments of support structure 125 may have mounting prongs 126 or suction cups 140, but not both simultaneously. As an optional feature, one or more hinges 130 can be provided to enable support structure 125 to fold for ease of transport and storage. To enable attachment of optional accessories, one or more coupling holes 135 can be provided on support structure 125. In an alternate embodiment support structure 125 couples to substrate 105 at a single position behind mirror 101.

In another embodiment of the present invention, support structure 125 is provided with one or more adjustable slide rails 127 to facilitate height adjustment by raising or lowering backing mirror 100 relative to the filed of view available from within the cab of a tow vehicle. An adjustable support structure 125 permits precise positioning of backing mirror 100 in order to accommodate operators of varying heights, or vehicles having varying dimensions. Adjustable slide rails 127 can be adjusted up or down as needed. FIG. 1B illustrates a perspective view of backing mirror 100 having an adjustable support structure 125 in accordance with an embodiment of the present invention. In another embodiment support structure 125 is a component of the assembly comprising a position holder.

Support structure 125 is coupled to substrate 105 via one or more angulated position holders 120. Angulated position holder 120 slides over shaft 115 and facilitates rotational movement of substrate 105 and mirror 101 relative to support structure 125. Angulated position holder 120 is adapted to rotate in discrete, stepwise units in order to maintain position and impart tactile registry to signal the advancement of a single unit. Thus, each unit of discrete, stepwise rotational movement of angulated position holder 120 can be felt as mirror 100 is adjusted to position.

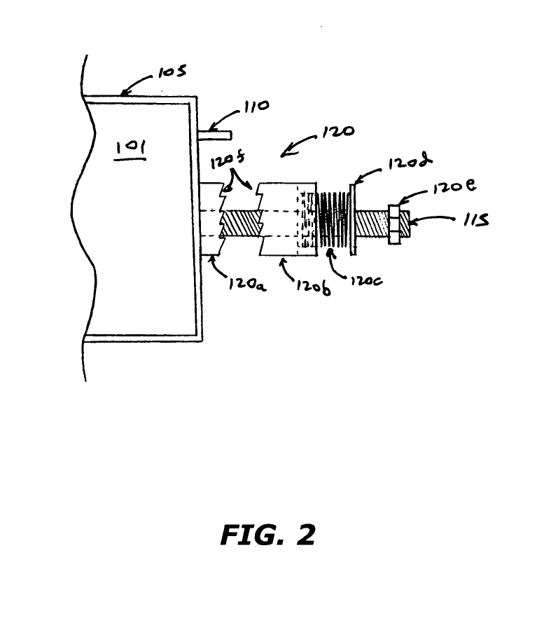

FIG. 2 illustrates an elevation view of an angulated position holder 120 in accordance with an embodiment of the present invention. Angulated position holder 120 surrounds shaft 115 and is comprised of sections 120a and 120b, spring 120c and washer 120d. Lock nut 120e may tighten directly against washer 120d, or, alternatively, tighten against support structure 125 when support structure 125 abuts up against washer 120d and is thus disposed between washer 120d and lock nut 120e. Sections 120a and 120b slidably interlock through meshing components 120f. Section 120b has a hollow to receive and retain spring 120c. Spring 120c maintains tension between sections 120a and 120b to engage meshing components 120f and inhibit free rotation of substrate 105 and mirror 101. Section 120a is coupled to substrate 105 in order to rotate when substrate 105 rotates. Section 120a may be coupled to substrate 105 via adhesive, screw, or other methods known to those of ordinary skill in the art. Thus, when rotational force is applied to substrate 105, the force is transferred through 120a to section 120b. When the rotational force is sufficient to overcome the frictional force imparted by spring 120c to hold meshing components 120f together, the substrate 105 and mirror 101 will rotate. Meshing components 120f are formed so that rotation occurs in discrete, stepwise units. Though the illustration in FIG. 2 depicts the meshing components 120f as teeth, alternate embodiments can employ a ratchet type assembly, or two parallel washers having a plurality of holes along their face to permit a ball bearing to slide between holes in a discrete, stepwise manner, or other methods providing suitable meshing components 120f known to those of ordinary skill in the art. To permit substrate 105 and mirror 101 to freely rotate, section 120b can be pressed against spring 120c to compress spring 120c and relieve tension against section 120a. This enables rapid adjustment of mirror 101 and ease in locating stop-pin 110. FIG. 2 illustrates shaft 115 as continuously threaded, alternate embodiments, however, may feature a partially threaded shaft 115, such end-threading in order to receive locking nut 120e.

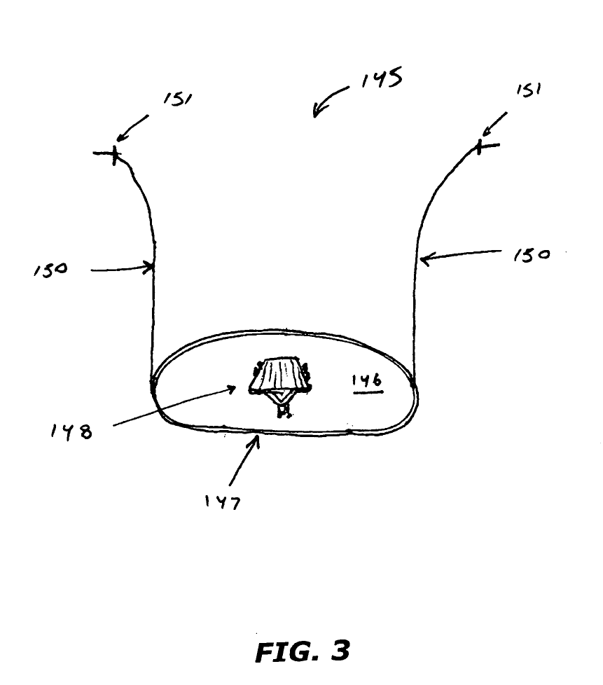

FIG. 3 illustrates an elevation view of backing mirror 100 employing an optional second mirror 145 in accordance with an embodiment of the present invention. Second mirror 145 is comprised of mirror 146 and substrate 147. Mirror 146 can be flat for a natural field of view, convex for a wide field of view, or concave for a narrow field of view. When used, second mirror 145 couples to support structure 125 (FIGS. 1A,B) via arms 150. In the embodiment illustrated in FIG. 3, arms 150 are spring-tensioned wires that interface with coupling holes 135 (FIGS. 1A,B) on support structure 125. Position locks 151 may be provided to maintain second mirror 145 in a desired position. Spring tension in arms 150 may also be adequate to maintain position of second mirror 145 on their own. To raise or lower second mirror 145, arms 150 are drawn up or down relative to support structure 125. In an alternate embodiment, arms 150 can be rigid. Image 148 depicts an item in the horizontal plane of the tow vehicle, which in FIG. 3 is a trailer bed.

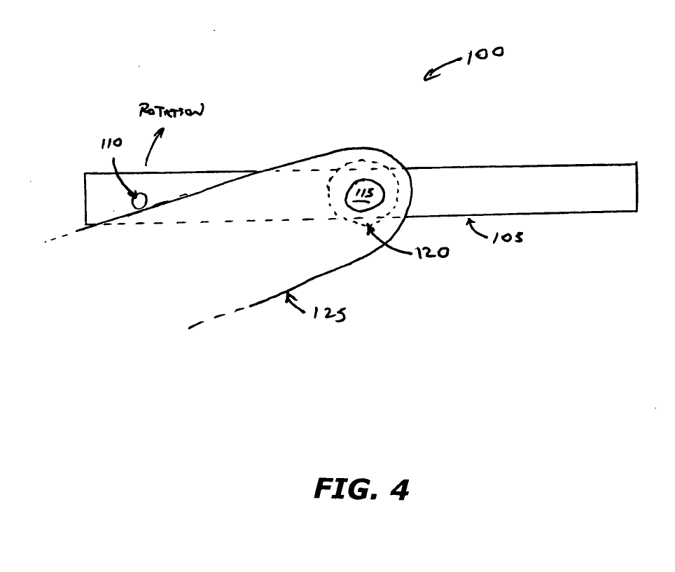

FIG. 4 illustrates an elevation view of backing mirror 100 initialized to a reference position in accordance with an embodiment of the present invention. Mirror 101 (FIGS. 1A,B) and substrate 105 are rotated about shaft 115 to a position where stop-peg 110 makes contact with support structure 125. The position of backing mirror 100 where stop-peg 110 makes contact with support structure 125 can be referred to as a reference position and the process of obtaining this position can be referred to as initializing. Note that backing mirror 100 can be rotated in either direction and in so doing stop-peg 110 may contact either side of support structure 125. Thus, two reference positions are available to choose from. Angulated position holder 120 is adapted to rotate in discrete, stepwise units in order to maintain control of the position of substrate 105 relative to support structure 125.

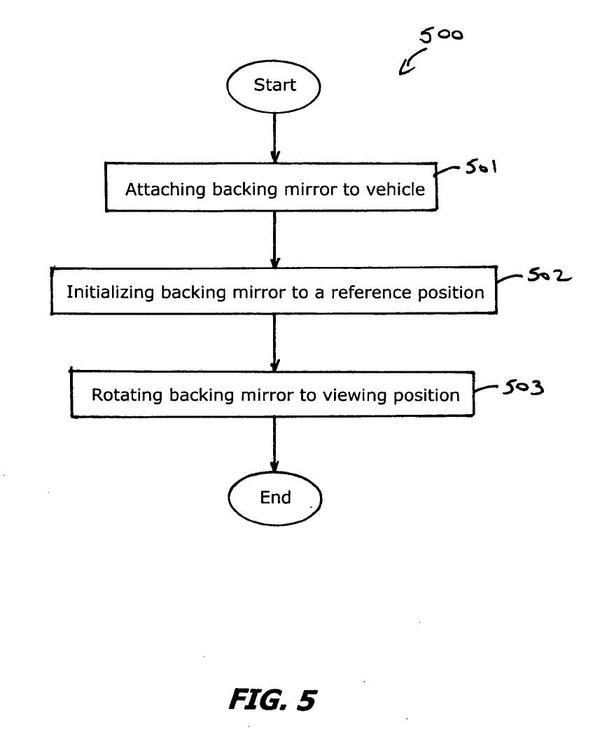

FIG. 5 illustrates flow diagram 500 presenting a method of using backing mirror 100 in accordance with an embodiment of the present invention. At step 501, backing mirror 100 is attached to a vehicle. Backing mirror 100 attaches to a vehicle by fitting over a protrusion, such as a tail-gate or bumper. In one embodiment, backing mirror 100 is removably attached. This enables backing mirror 100 to be used only when needed and then stored away for safekeeping when coupling trailer hitch and tongue is complete. For convenience, backing mirror 100 may have a hinged support structure to facilitate storage. Because tow hitch assemblies can be installed on the front of a vehicle as well as the back, alternate embodiments of backing mirror 100 are configured for vehicle front mounting. In other embodiments backing mirror 100 is permanently attached to the tow vehicle. Such an embodiment is useful for vehicles that perform numerous towing operations whereby it would be inconvenient to remove and store the backing mirror between tows.

At step 502, the backing mirror is initialized to a reference position. After backing mirror 100 is attached in step 501, the mirror must be initialized to a reference position so that it can be quickly and accurately set to a viewing position. The reference position is any position that is identifiable, i.e., known, and can be consistently located with precision. Thus, the reference position can serve as a base from which the backing mirror 100 is adjusted. Because many vehicles have differing shapes and contours, thus differing locations on which backing mirror 100 is to be attached, the reference position is likely to vary from one vehicle to the next. In one embodiment of the present invention, backing mirror 100 is equipped with stop-peg 110. To initialize backing mirror 100 to a reference position using a stop-peg, backing mirror 100 is rotated so that stop-peg 110 abuts up against support structure 125. In an alternate embodiment, backing mirror 100 is equipped with magnetic signaling capability so that initialization to a reference position can occur by virtue of the presence of a certain magnetic field. This can be accomplished by strategically locating one or more permanent magnets on substrate 105 and/or support structure 125 with corresponding detectors appropriately positioned, such as magnetically sensitive sensors such as reed switches. When magnet and sensor are aligned, a signal is generated to indicate location of the reference position. The signal can be an audible tone, a visual display such as illumination of a lamp, vibration, or other signaling method known to those of ordinary skill in the art. In additional alternate embodiments initialization can occur by virtue of an optical trigger or, alternatively, an infrared trigger. Such embodiments would require an optical source, such as LED, and detector, and infrared source and detector, respectively. When source and detectors are aligned, a signal can be generated to indicate location of the reference position.

At step 503, backing mirror 100 is rotated from its reference position to a viewing position. For each vehicle that backing mirror 100 is to be attached, there is optimal positioning such that backing mirror 100 is vertically aligned with the vehicle so as to be in optical communication with the tow hitch hook-up. Thus, a viewer in the cab of the tow vehicle can observe the positioning of the tow hitch without having to leave the cab. Rotation of backing mirror 100 is accomplished via angulated position holder 120, which is formed having a plurality of discrete meshing components 120f. Meshing components 120f enable angulated position holder 120 to be capable of consistent discrete, stepwise movement. Thus, once the reference position is established, the viewing position can be identified by the quantity of meshing components 120f, i.e., units, that angulated position holder 120 must be rotated or stepped through to change from a reference position to viewing position. Because this quantity remains fixed for each vehicle, alignment of backing mirror 100 is as simple as locating a reference position and then rotating backing mirror 100 though a predetermined, i.e., known, quantity of meshing components 120f for a given vehicle.

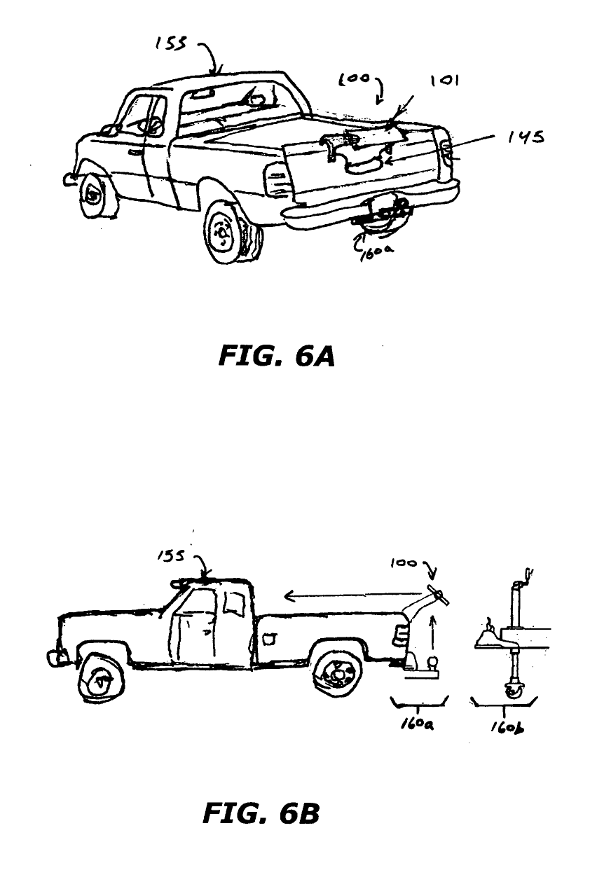

FIG. 6A illustrates a perspective view of backing mirror 100 mounted on tow vehicle 155 in accordance with an embodiment of the present invention. FIG. 6B illustrates an elevation view of backing mirror 100 mounted on tow vehicle 155 showing hitch 160a and tongue 160b prior to coupling in accordance with an embodiment of the present invention. Trailer hitch 160a is a device that allows a vehicle to tow a trailer. Hitches for passenger cars and trucks fall into three categories: weight-carrying hitches and weight-distributing hitches, which use a ball-mount design, and fifth-wheel hitches. Some companies offer replacement bumpers for trucks and SUVs that are designed to accommodate a ball hitch. Hidden hitches are available for many vehicles, as well. The trailer tongue 160b is the front part of a trailer or towed vehicle, which includes the coupler to connect to a hitch ball. The trailer coupler is the part of a trailer tongue that attaches to a hitch ball to connect a trailer to a tow vehicle.

FIGS. 6A and 6B depict backing mirror 100 as being vertically aligned with tow vehicle 155 so as to be in optical communication with hitch hook-up 160a. Thus, hitch 160a is visible from within the cab of tow vehicle 155. As tow vehicle 155 approaches trailer tongue 160b, tongue assembly 160b becomes visible within backing mirror 100. Because both hitch 160a and tongue 160b are visible within backing mirror 100, tow vehicle 155 can be maneuvered so that hitch 160a is located directly under tongue 160b for coupling. Thus, coupling of hitch 160a and tongue 160b can be achieved without the tow vehicle operator having to step out of the vehicle for visual inspection and subsequent re-alignment.

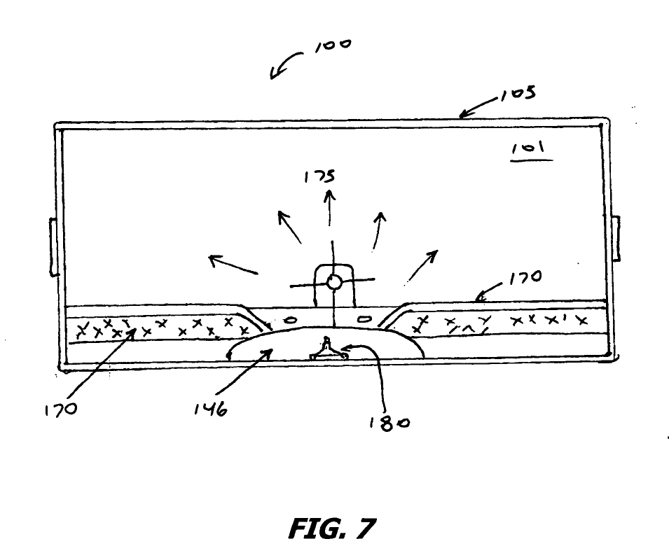

FIG. 6A illustrates positioning of optional second mirror 145 relative to first mirror 101. Second mirror 145 is horizontally aligned with tow vehicle 155 and reflects the image of objects that are behind tow vehicle 155 and out of the field of view of an operator in the cab. Tow vehicles 155 often sit high off the ground and thus enable limited visibility over their back end. Although backing mirror 100 permits an operator to see vertically down, horizontally view back behind the vehicle is difficult to obtain with just mirror 101 alone. Use of a convex mirror as mirror 101 provides some level of back viewing, but second mirror 145 provides a greater field of view, often wider than the tow vehicle itself, and is thus an excellent safety feature. Images captured by second mirror 145 are reflected up to mirror 101, which in turn are visible to an operator in the cab of tow vehicle 155. Second mirror 145 is particularly convenient to reflect images of small objects or entities in motion. Thus, second mirror 145 is ideal to reflect the image of such entities as children and animals. FIG. 7 illustrates a mirror 101 view of backing mirror 100 employing optional second mirror 145 in accordance with an embodiment of the present invention. Arrows 175 depict the back horizontal field of view visible in mirror 146, which in turn is visible in the view of mirror 101. The back horizontal field of view appears in FIG. 7 as image 180, which in the illustration of FIG. 7 happens to be a trailer.

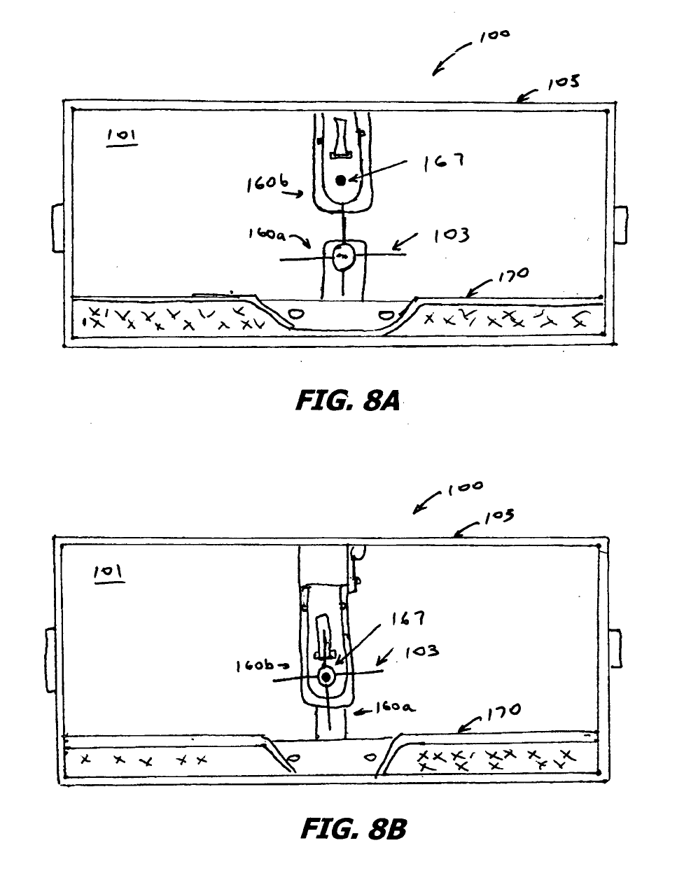

FIG. 8A illustrates a mirror 101 view of backing mirror 100 prior to alignment of trailer hitch 160a and tongue 160b in accordance with an embodiment of the present invention. Hitch 160a is depicted as protruding from bumper 170. Mirror 101 is depicted as having optional guidance indicia 103, or “sight,” to facilitate alignment of trailer hitch 160a and tongue 160b. Tongue 160b is depicted as having indicia 167 on its coupler. Indicia 167 is helpful because when hitch 160a is below tongue 160b it is no longer visible in mirror 101. Occasionally, hitch 160a may travel too far behind tongue 160b and thus not be in alignment. Because guidance indicia 103 is aligned with the ball of hitch 160a, when guidance indicia 103 aligns with indicia 167, hitch 160a is perfectly below tongue 160b for coupling. FIG. 8B illustrates a mirror 101 view of backing mirror 100 when the hitch 160a and tongue 160b are aligned and ready for coupling.

Numerous characteristics and advantages have been set forth in the foregoing description, together with details of structure and function. The novel features are pointed out in the appended claims. This disclosure, however, is illustrative only and changes may be made in detail within the principle of the invention to the full extent indicated by the broad general meaning of the terms in which the appended claims are expressed. For example, the backing mirror disclosed herein is suitable for applications beyond coupling of trailer hitch and tongue, and is applicable to any activity requiring careful maneuvering of the rear of a vehicle when positioning is viewable down from behind the vehicle, but not from the cab.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

All documents referred to herein are specifically incorporated herein by reference in their entireties.

As used herein and in the following claims, articles such as “the”, “a” and “an” can connote the singular or plural.

1. A backing mirror assembly, comprising:
a mirror;
a substrate coupled to said mirror, said substrate being adapted to retain said mirror;
a shaft, formed of at least one component, coupled to said substrate;
at least one angulated position holder rotatably coupled to said substrate and adapted to receive said shaft; and
a support structure coupled to said substrate,
wherein said at least one angulated position holder is located between said substrate and said support structure to facilitate rotational movement of said substrate relative to said support structure.

2. The backing mirror assembly of claim 1, wherein a sight is positioned on said mirror.

3. The backing mirror of assembly claim 1, wherein said support structure comprises at least one support arm.

4. The backing mirror assembly of claim 3, wherein each of said support arms is foldable.

5. The backing mirror assembly of claim 1, wherein at least one suction cup is coupled to said support structure.

6. The backing mirror assembly of claim 1, wherein said support structure is adapted to fit on a tail-gate.

7. The backing mirror assembly of claim 1, wherein said support structure is adapted to fit on a bumper.

8. The backing mirror assembly of claim 1, wherein at least one stop-peg is coupled to said substrate.

9. The backing mirror assembly of claim 1, wherein said at least one angulated position holder comprises a plurality of discrete meshing components configured to impart tactile registry during stepwise rotational movement.

10. The backing mirror assembly of claim 1, wherein said support structure comprises at least one adjustable slide rail to facilitate height adjustment.

11. A backing mirror assembly, comprising:
a first mirror;
a substrate coupled to said first mirror, said substrate being adapted to retain said first mirror;
a shaft coupled to said substrate, said shaft being formed of at least one component;
at least one angulated position holder rotatably coupled to said substrate and adapted to receive said shaft;
a support structure coupled to said substrate,
wherein said at least one angulated position holder is located between said substrate and said support structure to facilitate rotational movement of said substrate relative to said support structure; and
a second mirror coupled to said support structure.

12. The backing mirror assembly of claim 11, wherein said second mirror is convex.

13. The backing mirror assembly of claim 11, wherein said second mirror is coupled to said support structure via spring tensioned wires.

14. The backing mirror assembly of claim 11, wherein said second mirror is slideably coupled to said support structure.

15. A backing mirror assembly, comprising:
a mirror having guidance indicia;
a substrate coupled to said mirror, said substrate being adapted to support and retain said mirror;
a shaft, formed of at least one component, coupled to said substrate;
at least one angulated position holder rotatably coupled to said substrate and adapted to receive said shaft; and
a support structure coupled to said substrate,
wherein said at least one angulated position holder is located between said substrate and said support structure to facilitate rotational movement of said substrate relative to said support structure.

16. A method of using a backing mirror, the method comprising:
attaching said backing mirror to a vehicle having a tow hook-up, said backing mirror having an angulated position holder coupled to a support structure;
initializing said backing mirror to a reference position; and
rotating said backing mirror via said angulated position holder a predetermined quantity of units from said reference position to a viewing position, said units representing discrete stepwise rotational advancement configured to impart tactile registry,
wherein said predetermined quantity of units establish said backing mirror as vertically aligned relative to said vehicle so as to be in optical communication with said tow hook-up.

17. The method of using a backing mirror of claim 16 wherein said backing mirror is removably attached to said vehicle.

18. The method of using a backing mirror of claim 16, said backing mirror further having a stop-peg, wherein said initializing is accomplished by locating said stop-peg relative to said support structure.

19. The method of using a backing mirror of claim 16, said backing mirror further having magnetic signaling capability, wherein said initializing is facilitated by generation of a signal responsive to a magnetic field.

20. The method of using a backing mirror of claim 16, said backing mirror further having optical signaling capability, wherein said initializing is facilitated by generation of a signal responsive to an optical trigger.

21. The method of using a backing mirror of claim 16, said backing mirror further having infrared signaling capability, wherein said initializing is facilitated by generation of a signal responsive to an infrared trigger.

22. The method of using a backing mirror of claim 19, wherein said signal is an audible tone.

23. The method of using a backing mirror of claim 19, wherein said signal is a visual display.

24. The method of using a backing mirror of claim 19, wherein said signal is a vibration.

25. A mirror assembly for use with a towing vehicle and a towed vehicle, said assembly comprising:
a first and second mirror, at least one of said mirrors being convex, said mirrors being adapted to be coupled to a vehicle via at least one position holder, at least one of said mirrors including reference indicia capable of providing confirmation of accurate placement of said towing vehicle with said towed vehicle.

26. A mirror assembly for use with a towing vehicle and a towed vehicle, said assembly comprising at least one mirror capable of being attached to said towing vehicle via at least one position holder, said position holder including means for rotating said mirror to at least two positions, said positions being held in place via a ratchet mechanism and said positions being associated with a predetermined desired placement of said mirror so as to align said towing vehicle with said towed vehicle.
